(19) United States
(12) Patent Application Publication
(10) Pub. No.: US 2025/0018691 A1
(43) Pub. Date: Jan. 16, 2025

(54) ANTI-CORROSION TAPE COMPRISING AT LEAST FOUR PLIES

(71) Applicant: Denso-Holding GMBH & CO., Leverkusen (DE)

(72) Inventor: Thomas Markus KAISER, Inden (DE)

(73) Assignee: Denso-Holding GMBH & CO., Leverkusen (DE)

(21) Appl. No.: 18/294,049

(22) PCT Filed: Aug. 2, 2022
(86) PCT No.: PCT/EP2022/071737

§ 371 Date: Jul. 2, 2024

(30) Foreign Application Priority Data
Aug. 3, 2021 (EP) 10 2021 120 191.8

(51) Int. Cl. B32B 25/04; B32B 5/02; B32B 7/12; B32B 25/10; B32B 25/18; B32B 37/10; B32B 37/20; C09J 7/24; C09J 7/30; C09J 123/22; F16L 58/10; F16L 58/16

(52) U.S. Cl. CPC B32B 25/04; B32B 5/02; B32B 7/12; B32B 25/10; B32B 25/18; B32B 37/10; B32B 37/20; C09J 7/243; C09J 7/30; C09J 123/22; F16L 58/1063; F16L 58/16; B32B 2270/00; B32B 2307/202; B32B 2307/714; B32B 2405/00; C09J 2301/208; C09J 2423/00; C09J 2423/10

(57) ABSTRACT

Embodiments herein are directed to an anti-corrosion tape comprising at least four plies. At least two plies of the anti-corrosion tape, in the form of carrier plies, include an at least single-layer carrier, and at least one layer of the carrier is designed as a carrier layer. At least one other ply of the anti-corrosion tape is designed in the form of a connection ply and includes at least one connection layer, wherein the connection layer includes a material selected from a group consisting of at least one butyl rubber and/or at least one polyisobutene, and the at least one connection ply is arranged between the two carrier plies. At least one other ply of the anti-corrosion tape is designed as an anti-corrosion ply and is arranged on at least one exposed surface of at least one support ply.

### CROSS-REFERENCE TO RELATED APPLICATIONS

This application is a national-stage application under 35 U.S.C. § 371 of International Application No. PCT/EP2022/071737, filed Aug. 2, 2022, which International Application claims benefit of priority to German Patent Application No. 102021120191.8, filed Aug. 3, 2021.

### TECHNICAL FIELD

The disclosure relates to an anti-corrosion tape comprising at least four plies, a method for applying an anti-corrosion tape including at least four plies, a method for the production of an anti-corrosion tape including at least four plies, and the use of the latter.

### BACKGROUND

Anti-corrosion compositions and anti-corrosion systems, for example for pipe systems such as pipelines, but also for other technical systems, are known in many forms from the prior art. For example, EP 0 421 607 A1 discloses a tape system for protecting tubular objects, which comprises an inner wrapping covering the surface of the object to be protected, and an outer wrapping arranged over the inner wrapping, wherein the inner wrapping comprises an impact-resistant layer with an adhesive layer on its inner surface, and a layer on its outer surface, and wherein the outer wrapping comprises a carrier layer with a layer on at least one of its surfaces, wherein the inner wrapping and the outer wrapping include thermally-fusible material, wherein the tape system is applied to the tubular object such that upon heating and cooling the outer wrapping is thermally-fused to the inner wrapping, thereby forming a fully closed protective sheathing. The tape system disclosed therein is intended to achieve the object of bringing about an improvement against destructive external forces by providing a continuous, seamless, protective tape system. One of the adhesive layers can be made of butyl rubber, for example. The thermally-fusible materials used include ethylene vinyl acetate, ethylene methyl acrylate and low-density polyethylene. A problem with the tape system disclosed in EP 0 421 607 A1 is the contact between, for example, the outside of a pipeline pipe and the adhesive layer, for example made of butyl rubber, which can detach from the outside of the pipeline pipe and/or impair its mechanical properties, particularly at higher temperatures of sheathed pipe systems and technical systems of any kind. This is due in particular to a depolymerisation of the materials used, be it the thermally-fusible materials, or the carrier layer. Although adhesion can generally be improved by using solvent-based primers or adhesion promoters, this is often not sufficient and, above all, has no influence on the mechanical properties of the sheathing itself. In particular, this system can only be used with increased labour and costs, as an inner wrapping and an outer wrapping must be provided, meaning that a wrapping procedure must be carried out at least twice.

Furthermore, from the prior art of anti-corrosion systems there is a familiar problem that a leak can form and allow water to enter. The water can cause a special type of corrosion known as spiral corrosion, particularly in pipes wrapped with overlapping tape systems, such as pipelines and similar tubular items. Cathodic protection is therefore used to prevent such corrosion of the pipes. This protection is very effective in the event of mechanical damage to the anti-corrosion tape. Mechanical damage can be caused by the penetration of sharp objects, such as rocks or similar, and can result in the tape losing its adhesion to the substrate, for example, a pipeline. However, such leaks and corrosion can also be caused by ageing of the material of the anti-corrosion tape. Cathodic protection applies an electric current to the pipe so that sufficient electrons are provided to prevent corrosion. The pH value in the vicinity of the damaged area becomes alkaline, thus protecting the defective region. However, this cathodic protection cannot prevent corrosion along the spiral, as no conductive elements between the tape and pipe can transport the current in the overlap region. It is therefore important to provide a tape system with sufficient mechanical strength for corrosion protection: this is usually achieved by wrapping an additional protective tape around it to prevent damage to the tape system and thus prevent corrosion. This in turn increases the costs due to the additional operation of wrapping with a protective tape.

A fundamental disadvantage of the tape systems of known art is that a tape must be wrapped at least twice in order to provide sufficient protection against mechanical damage and thus achieve an adequate anti-corrosion effect.

### SUMMARY

It is the object of the present disclosure to provide an anti-corrosion tape which renders superfluous a second operation relating to the provision of pipes, pipelines, tubular objects, pipelines and pipeline constituent parts and the like with a protective tape. In addition, it is an object of the present disclosure to design an anti-corrosion tape such that it can have functions that can provide supplementary properties.

This object is achieved by an anti-corrosion tape comprising at least four plies, wherein at least two plies of the anti-corrosion tape comprise, as carrier plies, an at least single-layer carrier, wherein at least one layer of the carrier is configured as a carrier layer, wherein at least one further ply of the anti-corrosion tape is configured as a bonding ply and comprises at least one bonding layer, wherein the bonding layer includes a material selected from a group including at least one butyl rubber and/or at least one polyisobutylene, wherein the at least one bonding ply is arranged between the two carrier plies, and wherein at least one further ply of the anti-corrosion tape is configured as an anti-corrosion ply and is arranged on at least one exposed surface of at least one carrier ply.

An anti-corrosion tape in the context of the present disclosure serves in particular to provide corrosion protection, in particular wrapping, for pipes, pipelines, tubular items, piping systems and piping system constituent parts, as well as corrosion protection for tanks and constituent parts of tanks, as well as other systems and installations. The anti-corrosion tape has an inner surface and an outer surface, wherein the outer surface lies opposite to the inner surface. The inner surface is adjacent to the constituent part to be protected against corrosion. Furthermore, the anti-corrosion tape has a length, a width, and a thickness. The length and width each define opposite sides of the tape, wherein the length is assigned to the longer side, also known as the longitudinal edge, of the tape. The thickness or depth is a side of 40 the tape perpendicular to the surface, and defines a distance between the inner surface and the outer surface. Preferably, the anti-corrosion tape has a first longitudinal edge and a second longitudinal edge opposite the first longitudinal edge. In the end regions of the anti-corrosion tape, end face edges are arranged between the two, first and second, longitudinal edges that end there. The longitudinal edges define the longer side of the anti-corrosion tape and thus the length of the tape. A length of the tape preferably lies in a range between about 0.1 m and about 200 m, more preferably between about 1 m and about 140 m, even more preferably between about 5 m and about 70 m.

### DETAILED DESCRIPTION

In accordance with the disclosure, the anti-corrosion tape has at least four plies. A ply defines a single section of the anti-corrosion tape, which may extend over the entire surface of the anti-corrosion tape. A single ply of the anti-corrosion tape comprises a first surface and a second surface, wherein the second surface lies opposite the first surface. The first or second surface of a ply is arranged generally parallel to the inner/lower or outer/upper surface of the anti-corrosion tape. Furthermore, a ply has a length, a width, and a thickness, just like the anti-corrosion tape itself. The length and the width each define opposite sides of the ply, wherein the length is assigned to the longer side of the ply. The thickness or depth de-fines a distance between the first surface and the second surface of the respective ply. An arrangement of a plurality of plies is preferably carried out in the manner of a stack, wherein the arrangement is carried out by bringing the first or second surface of one ply into contact with the first or second surface of a further ply. A plurality of plies arranged on top of each other comprise a first outer ply, a second outer ply, and at least one centre ply arranged be-tween the first outer ply and the second outer ply. The surface of the first outer ply or the second outer ply, which are arranged opposite one another on a surface of a centre ply, is an exposed surface. The thicknesses or depths of the individual plies add up to the thickness or depth of the anti-corrosion tape. One ply of the anti-corrosion tape comprises at least one layer, preferably one ply of the anti-corrosion tape comprises at least two layers, more preferably a plurality of layers. In accordance with the disclosure, the anti-corrosion tape has at least four plies, preferably it has four, five, six or seven plies. In the context of the present disclosure, it is also possible for the anti-corrosion tape to have more than seven plies. The inventive anti-corrosion tape is preferably stretched. It is also possible for only one ply, preferably a carrier ply of the anti-corrosion tape, to be stretched.

In accordance with the present disclosure, the anti-corrosion tape comprises at least two plies as carrier plies, which include an at least single-layer carrier. A carrier ply is defined as the ply that comprises a carrier of the anti-corrosion tape. The anti-corrosion tape comprises at least two plies as carrier plies. Preferably, the anti-corrosion tape comprises exactly two plies as carrier plies. The anti-corrosion tape can also have more than two carrier plies. In accordance with the disclosure, the carrier is designed with at least a single layer. Preferably, the carrier has at least a further, second layer. Preferably, the carrier has at least a further, third layer. In accordance with the disclosure, the carrier can have more than three layers; preferably it has a single-layer, two-layer, or three-layer, structure. One layer of the carrier comprises a first surface and a second surface, wherein the second surface lies opposite the first surface. The first or second surface of a layer of the carrier is arranged generally parallel to the first or second surface of the carrier ply. In accordance with the disclosure, at least one layer of the carrier is configured as a carrier layer. The carrier layer is defined as the layer that acts as a load-bearing layer in the carrier, and can also provide stability to the anti-corrosion tape. Preferably, a carrier ply has exactly one carrier layer. The carrier layer has a first surface and a second surface, wherein the first surface lies opposite to the second surface. The at least one further, second layer, and the at least one further, third layer, are arranged either on the first or the second surface of the carrier layer. The at least one further, third layer is preferably arranged on the respectively other first or second surface of the carrier layer opposite the at least one further, second layer, and thus in such a way that the carrier layer is arranged between a second and a third layer.

Preferably, the carrier layer of at least one of the carrier plies is formed from a carrier material selected from a group comprising at least a polyethylene, a polypropylene, a polyvinyl chloride, a thermoplastic elastomer, and/or a metal. Preferably, the carrier layer is formed from a carrier material selected from a group comprising at least a polyethylene, a polypropylene, a polyvinyl chloride, a thermoplastic elastomer, and/or a metal. Preferably, the carrier layers of the at least two carrier plies are formed from a carrier material selected from a group comprising at least a polyethylene, a polypropylene, a polyvinyl chloride, a thermoplastic elastomer, and/or a metal. Preferably, the carrier layers of the at least two carrier plies are formed from the same carrier material.

Particularly preferably, the anti-corrosion tape includes at least four plies, wherein at least two plies of the anti-corrosion tape include an at least single-layer carrier as carrier plies, wherein at least one layer of the carrier is formed as a carrier layer, wherein the carrier layer is formed from a carrier material selected from a group including at least a polyethylene a polypropylene, a polyvinyl chloride, a thermoplastic elastomer and/or a metal, wherein preferably the carrier layers of the at least two carrier plies are formed from the same or identical carrier material, wherein at least one further ply of the anti-corrosion tape is configured as a bonding ply and comprises at least one bonding layer, wherein the bonding layer comprises a material selected from a group comprising at least a butyl rubber, and/or at least a polyisobutylene, wherein the at least one bonding ply is arranged between the at least two carrier plies, and wherein at least one further ply of the anti-corrosion tape is configured as an anti-corrosion ply, wherein the anti-corrosion ply comprises a material selected from a group comprising at least a butyl rubber, and/or at least a polyisobutylenc, wherein particularly preferably the anti-corrosion ply and the bonding ply are formed from the same material, and the anti-corrosion ply is arranged on at least one exposed surface of at least one carrier ply. Particularly preferably in this form of the embodiments, at least one electrically conductive material and/or core material can be present in the anti-corrosion ply and/or the bonding ply. In some embodiments, the materials of the bonding ply and the anti-corrosion ply are identical.

The at least one polyethylene that can be used as a carrier material is preferably selected from a group including high density polyethylene (HDPE), medium density polyethylene (MDPE), low density polyethylene (LDPE), linear low density polyethylene (LLDPE), high molar mass polyethylene (PE-HMW) and/or ultra-high molar mass polyethylene (PE-UHMW), wherein particularly preferably at least one MDPE and/or at least one HDPE is used. An MDPE preferably has a density between about 0.926 g/cm³ and about 0.939 g/cm³, an HDPE between about 0.94 g/cm³ and 0.97 g/cm³. The at least one polypropylene, which can also be used as a carrier material, is preferably selected from a group including isotactic polypropylene (iPP), syndiotactic polypropylene (sPP) and/or atactic polypropylene (aPP), where in an isotactic polypropylene is preferably selected. The isotactic polypropylene is preferably selected from a group including homopolymers, block copolymers and/or random copolymers. Ethene is preferably used as the copolymer. The at least one polyethylene and/or polypropylene can be used in the form of a master-batch, and may have a pigment additive. For example, carbon black or colour pigments can be added as pigments in an amount of about 0.5% by weight to about 10% by weight, more preferably in an amount in a range of about 1% by weight to about 4% by weight, based on the total amount of the carrier layer.

Polyvinyl chloride (PVC), which can also be used as a carrier material, is a specific thermoplastic polymer that is produced by chain polymerisation from the monomer vinyl chloride. Polyvinyl chlorides are divided into hard and soft polyvinyl chlorides. Soft polyvinyl chloride contains plasticisers that lead to an elastic behaviour of the material. Soft polyvinyl chloride is, for example, a carrier material that can be used in the carrier layer. Thermoplastic elastomers, which can also be used as a carrier material, are polymers that behave similarly to classic elastomers at room temperature, but can be plastically deformed when heat is applied and therefore exhibit thermoplastic behaviour. The at least one thermoplastic elastomer (TPE) is preferably selected from a group including thermoplastic styrene block copolymers (TPS-SEBS), and/or thermoplastic copolyester elastomers (TPC-ET). The basic molecular structure of TPS-SEBS is based on styrene-ethylenebutene-styrene block copolymers, in which the styrene blocks form the hard segments, and the ethenebutene blocks form the soft segments. TPC-ETs are copolyester-based TPEs with polyether soft segments. TPC-ET have a certain resistance to higher temperatures (application range up to around 160° C.) and damage (high strength and toughness).

Preferably, a TPS-SEBS can be used as a carrier material and has one or a plurality of the following parameters: a tensile strength in accordance with DIN 53504 (S2): 2017-03 in a range from about 20 N/mm² to about 25 N/mm² in the longitudinal direction and in a range from about 20 N/mm² to about 25 N/mm² in the transverse direction, an elongation at fracture in accordance with DIN 53504 (S2): 2017-03 in a range from approx. 600% to approx. 700% in the longitudinal direction, and in a range from approx. 650% to approx. 750% in the transverse direction, a stress at 50% elongation in accordance with DIN 53504 (S2): 2017-03 in a range from about 8 N/mm² to about 10 N/mm² in the longitudinal direction, and in a range from about 8 N/mm² to about 10 N/mm² in the transverse direction, and a density in accordance with DIN EN ISO 1183-1:2013-04 in a range from about 0.8 g/cm³ to about 0.95 g/cm³. Preferably, a TPC-ET that can be used as a carrier material has one or a plurality of the following parameters: a tensile strength in accordance with DIN 53504 (S2): 2017-03 in a range from about 10 N/mm² to about 20 N/mm² in the longitudinal direction, and in a range from about 12 N/mm² to about 18 N/mm² in the transverse direction, an elongation at fracture in accordance with DIN 53504 (S2): 2017-03 in a range from about 450% to about 550% in the longitudinal direction, and in a range from about 500% to about 650% in the transverse direction, a stress at 50% elongation in accordance with DIN 53504 (S2): 2017-03 in a range from approx. 4 N/mm² to approx. 14 N/mm² in the longitudinal direction, and in a range from approx. 4 N/mm² to approx. 14 N/mm² in the transverse direction, and a density in accordance with DIN EN ISO 1183-1:2013-04 in a range from approx. 0.95 g/cm³ to approx. 1.2 g/cm³.

If the term “approximately” or “essentially” is used in the context of the present disclosure in connection with values or value ranges or properties or geometries, this is to be understood as a tolerance range that the person skilled in the art considers to be customary in this field. In particular, a tolerance range of ±20%, preferably +10%, and more preferably ±5% is intended in connection with values or value ranges when the term “approximately” is used. Lower limits of value ranges can thus be undercut by 5% to 20%. Upper limits of value ranges can thus be exceeded by 5% to 20%. Insofar as different value ranges, for example preferred and more preferred value ranges, are specified in the present disclosure, the lower limits and the upper limits of the different value ranges can be combined with one another.

In accordance with the present disclosure, at least one further ply of the anti-corrosion tape is configured as a bonding ply, which preferably includes at least one bonding layer. The bonding ply serves to connect the carrier plies to one another, but preferably also serves simply to functionalise the anti-corrosion tape so that the anti-corrosion tape has additional properties such as, for example, a certain conductivity. Preferably, the bonding ply includes one or a plurality of bonding layers, more preferably one or two bonding layers.

In accordance with the present disclosure, the at least one bonding layer is produced from a material selected from a group including at least one butyl rubber and/or at least one polyisobutylene. Preferably, the at least one bonding layer may include a material selected from a group including at least a first, preferably depolymerised, butyl rubber having an apparent Brookfield viscosity at 66° C. in accordance with DIN EN ISO 2555:2000-01 in a range from about 400,000 mPa·s to about 2,000,000 mPa·s, and an average molar mass MW (also called the average molar mass or molecular mass) in a range from about 20,000 to about 60,000 and/or at least one first polyisobutylene with an average relative molar mass M v in a range from about 14,000 g/mol, preferably from about 30,000 g/mol, to about 150,000 g/mol, preferably up to about 100,000 g/mol, and a Staudinger index J₀ in a range from about 15 cm³/g to about 70 cm³/g, and at least one second butyl rubber, and/or at least one second polyisobutylene. The at least one second, preferably at least partially cross-linked, more preferably partially cross-linked, butyl rubber preferably has a Mooney viscosity ML(1+3) at 127° C. in a range from about 65 MU to about 100 MU in accordance with ISO 289:2005. The at least one second polyisobutylene preferably has a Staudinger index J₀ in a range from about 75 cm³/g to about 235 cm³/g and with an average relative molar mass M̅v in a range from about 150,000 g/mol, preferably from about 160,000 g/mol, up to about 950,000 g/mol, preferably up to about 850,000 g/mol, More preferably, the material of the at least one bonding layer may include a third butyl rubber and/or a third polyisobutylene. The at least one third, preferably solid, butyl rubber preferably has an average molar mass Mw in a range from about 150,000 to about 2,000,000 and a Mooney viscosity ML(1+8) at 125° C. in a range from about 20 MU to about 62 MU, measured in accordance with ISO 289:2005. The at least one third polyisobutylene preferably has an average relative molar mass M̅v in a range from about 900,000 g/mol, preferably from about 950,000 g/mol, to about 7,500,000 g/mol, preferably up to about 6,500,000 g/mol, and a Staudinger index J₀ in a range from about 240 cm³/g to about 900 cm³/g. Preferably, the at least one bonding layer includes a material selected from a group including at least a first polyisobutylene and/or a first butyl rubber and at least a second polyisobutylene and/or a second butyl rubber. More preferably, the bonding ply includes a material selected from a group including at least a first polyisobutylene and/or a first butyl rubber, at least a second polyisobutylene and/or a second butyl rubber, and at least a third polyisobutylene and/or a third butyl rubber. Particularly preferably, the at least one bonding layer includes at least one first or at least one second polyisobutylene as well as at least one first or at least one second butyl rubber. Even more preferably, the at least one bonding layer includes a first, a second and optionally a third butyl rubber, and no polyisobutylene. Even more preferably, the at least one bonding layer includes a first, a second and optionally a third polyisobutylene, and no butyl rubber. Alternatively, the bonding layer includes only a second butyl rubber or only a second polyisobutylene. In a further alternative configuration, the bonding ply includes only a third butyl rubber or only a third polyisobutylene. In a further alternative configuration the at least one bonding ply includes a material selected from a group including at least a second polyisobutylene and/or a second butyl rubber and at least a third polyisobutylene and/or a third butyl rubber, preferably a second polyisobutylene and a third butyl rubber or a third polyisobutylene and a second butyl rubber. However, the bonding ply may also include a second and a third polyisobutylene or a second and a third butyl rubber.

The Staudinger index J₀ was previously also referred to as intrinsic viscosity. It is calculated from the flow time at 20° C. through a capillary of an Ubbelohde viscometer in accordance with the following formula (Schulz-Blaschke equation):

$${J}_{0} = η sp / c ( 1 + {0.31}^{\times } η sp ) cm / {g}^{3} \\ wherein \\ {η}_{sp} = \frac{t}{{t}_{o}} - 1 \\ ( specific viscosity ) ,$$

wherein t is the flow time of the solution with a Hagenbach-Couette correction, to is the flow time of the isooctane solvent with Hagenbach-Couette correction and c is the concentration of the solution in g/cm³. The average relative molar mass M̅v (viscosity agent) is calculated from the following formula:

$$\sqrt[0.65]{\frac{{J}_{o} \times {10}^{2}}{3.06}}$$

Polyisobutylenes within the meaning of the present disclosure are preferably synthesised via a cationic polymerisation of isobutene (2-methylpropene) in a temperature range between about −100° C. and about 0° C. The temperature influences the molar mass of the polyisobutene produced in this way, the lower the temperature, the higher the molar mass of the same. Usually boron trifluoride or aluminium trichloride in aqueous or alcoholic solution are used as initiators.

The at least one first polyisobutylene advantageously has a Staudinger index J₀ in a range from about 22 cm³/g to about 65 cm³/g, and even more preferably a Staudinger index J₀ in a range from about 25 cm³/g to about 45 cm³/g. Preferably, the at least one first polyisobutylene has an average relative molar mass MV (viscosity average) in a range from about 24,000 g/mol, preferably from about 35,000 g/mol, to about 130,000 g/mol, preferably up to about 95,000 g/mol, and more preferably an average relative molar mass M̅V in a range from about 30,000 g/mol, preferably from about 37.000 g/mol, to about 75,000 g/mol, preferably up to about 70,000 g/mol, The at least one first polyisobutylene is advantageously included in an amount in a range from about 28% by weight to about 60% by weight. More preferably in an amount in a range from about 33% by weight to about 50% by weight, in each case based on the total amount of the at least one bonding layer.

The at least one second polyisobutylene preferably has a Staudinger index J₀ in a range from about 106 cm³/g to about 160 cm³/g. Preferably, the at least one second polyisobutylene has an average relative molar mass MV in a range from about 250,000 g/mol to about 600,000 g/mol, preferably up to about 550,000 g/mol, Preferably, the at least one second polyisobutylene is comprised in an amount in a range from about 10% by weight to about 35% by weight, more preferably in an amount in a range from about 13% by weight to about 28% by weight, in each case based on the total amount of the at least one bonding layer.

The at least one third polyisobutylene preferably has a Staudinger index J₀ in a range from about 400 cm³/g to about 800 cm³/g, and even more preferably a Staudinger index J₀ in a range from about 500 cm³/g to about 700 cm³/g. Preferably, the at least one third polyisobutylene has an average relative molar mass M̅V in a range from about 1,500,000 g/mol, preferably from about 2,000,000 g/mol, to about 6,000,000 g/mol, preferably up to about 5,000,000 g/mol, more preferably in a range from about 3,000,000 g/mol to about 5,000,000 g/mol, preferably up to about 4,800,000 g/mol, The at least one third polyisobutylene is advantageously comprised in an amount in a range from about 1% by weight to about 20% by weight, more preferably in an amount in a range from about 2% by weight to about 10% by weight, still more preferably in an amount in a range from about 3% by weight to about 8% by weight, in each case based on the total amount of the at least one bonding layer.

The ratio of the at least one first polyisobutylene, that is to say, the total amount of the first polyisobutylene used, even if a mixture is present, to the at least one second polyisobutylene, that is to say, the total amount of the second polyisobutylene, even if this is present in a mixture, is advantageously in a range from about 2.5:1 to about 1:2.5, more preferably in a range from about 2.2:1 to about 1:1.

The polyisobutylenes used, that is to say, both the first, the second and the third polyisobutylene, advantageously have a glass transition temperature Tg (measured calorimetrically by DSC) of less than −50° C., more preferably less than −58° C. Particularly preferably, the glass transition temperature of the at least one first, the at least one second and the at least one third polyisobutylene is in a range from about −55° C. to about −68° C., more preferably in a range from about −58° C. to about −66° C. The higher molar mass, at least one second polyisobutylene can thus still be addressed as a highly viscous liquid and has a certain tendency to creep.

In the context of the present disclosure, the term butyl rubber is understood in particular to mean co- or block co-polymers of isobutene with about 0.5% by weight to about 5% by weight of isoprene, based on the total amount of butyl rubber; these are produced in particular by cationic polymerisation. A cross-linking reaction can be initiated via the isoprene used and the carbon-carbon double bonds present therein, which act as functional groups. In the context of the present disclosure, the term butyl rubber also includes, in particular, halogenated butyl rubbers, especially those which are chlorinated or brominated (chlorobutyl rubber or bromobutyl rubber). Mixtures of a plurality of butyl rubbers can also be used, that is to say, more than at least one butyl rubber.

The at least one first, preferably depolymerised, butyl rubber is preferably obtained by depolymerisation of butyl rubbers (IIR). The at least one first butyl rubber has a low molar mass. It is particularly preferably present in liquid form at 23° C. In contrast, the at least one third butyl rubber is not depolymerised and has a high molar mass compared to the first butyl rubber. The at least one third butyl rubber is preferably present in solid form at 23° C.

The at least one first, preferably depolymerised, butyl rubber preferably has an apparent Brookfield viscosity in accordance with DIN EN ISO 2555:2000-01 at 66° C. in a range from about 600,000 mPa·s to about 1,600,000 mPa·s, more preferably in a range from about 700,000 mPa·s to about 1,500,000 mPa·s. Preferably, the at least one first, preferably depolymerised, butyl rubber has an average molar mass Mw in a range from about 20,000 to about 60,000. The at least one first, preferably depolymerised, butyl rubber advantageously has the property of undergoing a cross-linking reaction even at low temperatures, in particular at room temperatures of for example 20° C. or 23° C., or even at slightly elevated temperatures of for example 40° C. to 50° C., due to the unsaturated carbon-carbon double bonds present therein. Preferably, the first butyl rubber is comprised by the bonding ply in an amount in a range from about 20% by weight to about 66% by weight, preferably in an amount in a range from about 28% by weight to about 60% by weight, more preferably in an amount in a range from about 33% by weight to about 50% by weight, in each case based on the total amount of the at least one bonding layer.

The at least one second, at least partially cross-linked (hereinafter also referred to as partially pre-cross-linked) butyl rubber, which has a lower proportion of unsaturated bonds than conventional butyl rubbers, preferably has a Mooney viscosity ML(1+3) at 127° C. in a range from about 70 MU to about 93 MU, more preferably in a range from about 78 MU to about 91 MU, measured in accordance with ISO 289:2005 or in accordance with ASTM 1604-04. The specific density of the at least one second, partially cross-linked butyl rubber is advantageously in a range from about 0.5 to about 1.1 at a temperature of 25° C. in accordance with ASTM D1875 in the 2003 version, preferably in a range from about 0.9 to about 0.98.

Particularly preferably, the second butyl rubber is comprised of the at least one bonding layer in an amount in a range from about 1% by weight to about 20% by weight, more preferably in an amount in a range from about 2% by weight to about 10% by weight, still more preferably in an amount in a range from about 3% by weight to about 8% by weight, in each case based on the total amount of the at least one bonding layer.

The at least one third butyl rubber advantageously has an average molar mass Mw in a range from about 200.000 to about 1,800,000, more preferably in a range from about 250,000 to about 600,000. Preferably, the at least one third butyl rubber has a Mooney viscosity ML(1+8) at 125° C. in a range from about 30 MU to about 60 MU, more preferably in a range from about 40 MU to about 59 MU, still more preferably in a range from about 40 MU to about 55 MU, measured in accordance with ISO 289:2005. The at least one third butyl rubber is advantageously comprised of the at least one bonding layer in an amount in a range from about 10% by weight to about 50% by weight, more preferably in an amount in a range from about 15% by weight to about 35% by weight, in each case based on the total amount of the at least one bonding layer.

Advantageously, the at least one third butyl rubber has unsaturation values in a range from about 1 mol % to about 3 mol %, more preferably in a range from about 1.3 mol % to about 2.5 mol %. This means that preferably about 1 mol-% to about 3 mol-%, more preferably about 1.3 mol-% to about 2.5 mol-% of unsaturated bonds, that is to say, carbon-carbon double bonds, are present as functional groups in the at least one third butyl rubber. Particularly preferably, the at least one third butyl rubber is produced by a copolymerisation of isobutene and isoprene in methyl chloride as solvent. The unsaturation (the degree of unsaturation) of the at least one third butyl rubber may also be about 1.5 mol-%, in particular about 1.5±0.5 mol-%.

In addition to polyisobutylene and/or butyl rubber, the at least one bonding layer preferably includes at least one filler material, at least one antioxidant, at least one cross-linking agent, at least one elastomer, and/or at least one stabilising agent. The other constituent parts mentioned can be added to the at least one bonding layer alone or in combination. Particularly preferably, the at least one bonding layer includes at least one filler material. The at least one filler material is preferably comprised in an amount in a range from about 20% by weight to about 70% by weight, more preferably in an amount in a range from about 30% by weight to about 65% by weight, and still more preferably in an amount in a range from about 33% by weight to about 50% by weight, in each case based on the total amount of the at least one bonding layer. Particularly preferably, the at least one filler material is powdered or fibrous. In the context of the present disclosure, the term fibrous also includes such filling materials which have a needle-like structure. Particularly preferably, the at least one bonding layer includes at least one first powdered filler material and at least one second fibrous filler material. In such a combined addition of at least one powdered and at least one fibrous filler material, it is particularly preferred that the fibrous filler material is added in an amount up to a maximum of that of the powdered filler material. A powdered as well as a fibrous filler material can be comprised in the at least one bonding layer in an amount in a range from about 10% by weight to about 40% by weight, preferably in an amount in a range from about 12% by weight to about 25% by weight, in each case based on the total amount of the at least one bonding layer.

Preferably, the at least one filler material is selected from a group of powdered mineral fillers, or from mineral and/or organic fibre-like fillers. For example, it may be made of metal, zinc oxide, cellulose fibres, wollastonite in needle form, or the like. It may also be selected from a group of organic fibres such as acrylonitrile fibres with a length in a range from about 1.5 mm to about 20 mm, more preferably with a length in a range from about 4 mm to about 15 mm, and a fineness in a range from about 0.5 dtex to about 100 dtex, more preferably with a fineness in a range from about 1 dtex to about 20 dtex, each measured in accordance with ISO 1144 in the 1973 version. Insofar as a powdered filler, in particular a mineral powdered filler, is used, this advantageously has a residue in % in a sieve analysis in accordance with DIN 66165 in the 1987-04 version at H-100 (100 μm) of about 1% to about 5%, at H-60 (60 μm) of about 1% to about 5% and at H-30 (30 μm) in a range of about 1% to about 5%. Advantageously, the at least one bonding layer has at least one filler material. If the filler material is in powdered form, it is advantageously selected from the group of mineral fillers and is particularly preferably a talcum.

The at least one elastomer is advantageously selected from a group including at least one ethylene-propylene-diene rubber. In particular, this includes co-polymers or block co-polymers as well as terpolymers, which as functional groups have a carbon-carbon double bond. Mixtures of these can also be used. Terpolymers that are formed from a polymerisation reaction with ethylene, propylene and a diene are particularly preferred. These are also known as EPDM terpolymers and combine a saturated polymer backbone with unsaturated residues in side groups. Particularly preferred in the context of the present disclosure are 5-ethylidene-2-norbornene, dicyclopentadiene and/or 5-vinylidene-2-norbornene as a diene, namely in amounts up to about 15% by weight, preferably in amounts in a range from about 0.3% by weight to about 12% by weight. In the case of the use of 5 ethylidene-2-norbornene, amounts in a range from about 0.5% by weight to about 11% by weight are preferably used, and in the case of the use of dicyclopentadiene, amounts in a range from about 1.0% by weight to about 6.0% by weight are used. The above percentages by weight in this paragraph are based on the total amount of monomers used in a polymerisation to form an EPDM or ethylene-propylene rubber.

Where at least one antioxidant is provided, this can be comprised of the latter, preferably in a mixture of different antioxidants, in an amount in a range from about 0.1% by weight to about 1% by weight, more preferably in an amount in a range from about 0.15% by weight to about 0.5% by weight, in each case based on the total amount of the at least one bonding layer. An antioxidant is a chemical bonding that slows down or completely prevents the oxidation of other substances. In particular, the antioxidant may be selected from a group including sterically-inhibited phenols, such as pentacrythriol tetrakis (3-(3,5-di-ter-butyl-4-hydroxiphenyl) propionate). A sterically-inhibited phenolic antioxidant provides protection against thermo-oxidative degradation in the inventive anti-corrosion tape. These exhibit good compatibility in the latter. The antioxidant can be used in combination with other additives such as stabilising agents. The pentaerythriol tetrakis (3-(3.5-di-ter-butyl-4-hydroxiphenyl) propionate) mentioned as an example is powdered, white to whitish, insoluble in water and has a molar mass of about 1176.5 g/mol and a melting range of about 110° C. to about 125° C. Tris(2.4-di-tert-butylphenyl)phosphite can be used as a further preferred antioxidant. Tris(2,4-di-tert-butylphenyl)phosphite is powdered, white to whitish in colour, has a molar mass of 646.92 g/mol and a melting range of about 181° C. to about 184° C.

If at least one stabilising agent, which can also be referred to as a dispersing aid, is present in the at least one bonding layer, this is advantageously selected from a group including C10 to C24 carboxylic acids, and is advantageously stearic acid. The at least one stabilising agent is preferably present in an amount of the at least one bonding layer in a range from about 0.05% by weight to about 0.5% by weight, based on the total amount of the at least one bonding layer. Metal salts of the carboxylic acids mentioned, for example zinc stearates, or free carboxylic acids, such as free fatty acids with 12 to 24 carbon atoms, in particular stearic acid or oleic acid, can also be used as stabilising agents.

Furthermore, the at least one bonding layer may also have other additives that are customary and necessary depending on the intended use. In particular, the at least one bonding layer may further include at least one flame retardant and/or at least one cross-linking of the at least one bonding layer agent. If a flame retardant is provided, this is advantageously included in an amount of the at least one bonding layer in a range from about 0.02% by weight to about 2% by weight, based on the total amount of the at least one bonding layer.

In accordance with the disclosure, at least one further ply of the anti-corrosion tape is formed as an anti-corrosion ply. The anti-corrosion ply includes at least one anti-corrosion layer, more preferably exactly one anti-corrosion layer. The anti-corrosion ply serves to directly protect constituent parts from corrosion, in particular pipes, pipelines, tubular objects, piping systems and piping system constituent parts, tanks and constituent parts of tanks, systems and installations, as it comes into direct contact with the constituent part to be protected. Preferably, the anti-corrosion ply forms at least one outer ply of the anti-corrosion tape. Particularly preferably, the at least one anti-corrosion ply is in contact with the pipe or constituent part to be protected. More preferably, the anti-corrosion ply forms a first outer ply and a second outer ply of the inventive anti-corrosion tape. The anti-corrosion ply includes a material selected from a group including at least one butyl rubber and/or at least one polyisobutylene. The preferred butyl rubbers and/or polyisobutylenes and their mixtures and compositions have already been described above in connection with the design of the bonding layer. The information provided in connection with the formation of the at least one bonding layer applies accordingly to the layer or layers of the anti-corrosion ply, wherein the amounts are then based on the total amount of the at least one anti-corrosion layer. In particular, the at least one bonding layer and the at least one anti-corrosion layer can include butyl rubber and/or polyisobutylenc, which are identical, so that the at least one bonding layer and the at least one anti-corrosion layer can be of similar design with regard to the material and its properties. In particular, the at least one bonding layer and the at least one anti-corrosion layer can also be of identical design if no functionalisation is provided, or can be identical except for such functionalisation, for example by means of a conductive material. Each anti-corrosion ply is preferably designed in one or more layers, more preferably in a single layer.

Preferably, at least one of the carrier plies, preferably both carrier plies, is designed in such a way that these do not include fibres in a polymer matrix.

Preferably, the at least one layer configured as a carrier layer of at least one of the carrier plies is configured as a foil, non-woven fabric, woven fabric, net, knitted fabric, perforated foil or grid: particularly preferably the carrier layer is formed as a foil or grid. Preferably, the carrier layer is designed as a foil, fleece, fabric, net, scrim, knitted fabric, perforated foil or grid; particularly preferably the carrier layer is designed as a foil or grid. Particularly preferably, the carrier layers of the at least two carrier plies are designed as a foil, non-woven fabric, woven fabric, net, scrim, knitted fabric, perforated foil or grid; particularly preferably, the carrier layers of the at least two carrier plies are in the form of a foil or grid. The carrier layer is particularly preferably designed as a tape, but can also be configured in the form of a mat, or otherwise flat. In particular, the carrier layer can be configured in the form of a carrier foil, a shrink tape or tube, an overstretch prevention layer, or a grid. The configuration as a carrier foil or as an overstretch prevention layer, which is also designed in the form of a foil and preferably in the form of a tape, differs in particular in its thickness. If the carrier layer is configured as a carrier foil, it advantageously has a thickness in the range from about 0.2 mm to about 1.2 mm, and more preferably a thickness in the range from about 0.3 mm to about 1.0 mm. If the carrier layer is configured as an overstretch prevention layer, it preferably has a thickness in a range from about 15 μm to about 100 μm, more preferably in a range from about 20 μm to about 75 μm. The function of an overstretch prevention layer is to prevent overstretching of the anti-corrosion tape, in particular when the latter is wound spirally around a pipe, for example a pipeline, to be sheathed, but also, for example, when applying anti-corrosion to the bottom of a tank, for example, an oil tank. The carrier foil or the stretch brake can also be perforated. If the carrier layer is designed as a grid, it preferably has recesses which are formed by a cross-over arrangement of elongated parts. In the case of a single-layer carrier, the carrier layer itself can take the form of a fleece, fabric, net, scrim, knitted fabric, perforated foil, or grid.

Preferably, an adhesion-promoting layer is arranged on at least one surface of the carrier layer of at least one of the carrier plies as a further layer of the carrier ply. Preferably, an adhesion-promoting layer is arranged on at least one surface of the carrier layer as a further layer of the carrier ply, even more preferably on at least one surface of the carrier layers of the at least two carrier plies. More preferably, the carrier layer has an adhesion-promoting layer on both surfaces of the latter. When applied to both surfaces of the carrier layer, the two adhesion-promoting layers applied there may be identical, but may also be different. Preferably, the adhesion-promoting layer is applied over the entire surface of at least one surface of the carrier layer. The adhesion-promoting layer preferably has an adhesion-promoting composition including:
about 20% by weight to about 70% by weight of at least one polymer selected from a group including polyethylenes, polypropylenes, polyvinyl chlorides and/or thermoplastic elastomers; and
about 20% by weight to about 65% by weight of at least one butyl rubber and/or polyisobutylene:
   wherein the figures in percent by weight, abbreviated as wt-%, are based in each case on the total amount of the adhesion-promoting layer.

The adhesion-promoting layer more preferably has an adhesion-promoting composition including:
about 20% by weight to about 70% by weight of at least one polymer selected from a group including polyethylenes, polypropylenes, polyvinyl chlorides and/or thermoplastic elastomers;
about 20% by weight to about 65% by weight of at least one butyl rubber and/or polyisobutylene; and
about 6% by weight to about 35% by weight of at least one elastomer selected from a group including ethylene-propylene rubber and/or ethylene-propylene-diene rubber;
   wherein the figures in percent by weight, abbreviated as wt-%, are based in each case on the total amount of the adhesion-promoting layer.

The at least one polymer in the adhesion-promoting layer is preferably present in an amount of the same in a range from about 30% by weight to about 60% by weight, more preferably in an amount in a range from about 32% by weight to about 55% by weight, in each case based on the total amount of the adhesion-promoting layer. Particularly preferably, the adhesion-promoting layer includes exactly one polyethylene or exactly one polypropylene. With regard to its chemical and physical properties, the at least one polyethylene and/or polypropylene is preferably one as defined above in connection with the carrier layer.

Preferably, the at least one polymer in the at least one, preferably at least two, adhesion-promoting layers is electron-beam cross-linkable. More preferably, the carrier material that forms the carrier layer is also electron-beam cross-linkable. A medium-density or higher-density polyethylene, preferably electron-beam cross-linkable, or a polypropylene, preferably an isotactic polypropylene, is particularly preferred, wherein if polypropylene is used, it can preferably be used as a master-batch with at least one cross-linking accelerator and possibly suitable copolymers for successful electron-beam cross-linking. Electron beam cross-linking of the electron-beam cross-linkable polymers improves their temperature resistance in particular, but also their mechanical strength. If at least one polyethylene is used, this advantageously has a density of at least around 800 kg/m³, measured in accordance with ISO 1872-2/ISO 1183, and is preferably in a range of around 850 kg/m³ to around 1,000 kg/m³, more preferably in a range of around 900 kg/m³ to around 980 kg/m³. If at least one polypropylene is used, this advantageously has a density of preferably at least 800 kg/m³, measured in accordance with ISO 1872-2/ISO 1183, and is preferably in a range from about 850 kg/m³ to about 980 kg/m³, more preferably in a range from about 890 kg/m³ to about 960 kg/m³. Electron-beam cross-linking is advantageously carried out with β-rays, but can also be carried out with γ-rays. Preferably, irradiation is carried out with a dose in the range from about 25 kGy to about 250 kGy.

However, the at least one polymer does not have to be electron-beam cross-linkable, especially if other, alternative methods of cross-linking or bonding can be used, such as heat treatment. Heat treatment can also be used to cross-link or bond the adhesion-promoting layer or the carrier layer, for example with a bonding ply. The heat treatment is carried out at a temperature at which the viscosity of the constituent parts of the carrier layer or of the adhesion-promoting layer, in this case in particular of the at least one butyl rubber, and/or polyisobutylene, and/or of the at least one elastomer selected from a group including ethylene-propylene rubber, and/or ethylene-propylene-diene rubber, is reduced, preferably at about 150° C. to about 200° C., more preferably at about 160° C. to about 180° C. This can be achieved, for example, with an appropriate design of a calendar roll.

Preferably, the at least one butyl rubber in the adhesion-promoting layer is selected from a group including at least partially cross-linked and/or depolymerised butyl rubbers, more preferably such as those defined above with respect to their chemical and physical properties in the context of the at least one bonding layer of the bonding ply. Particularly preferably, the adhesion-promoting layer includes exactly one butyl rubber, preferably an at least partially cross-linked butyl rubber. In an alternative form of embodiment, the adhesion-promoting layer preferably includes exactly one at least partially cross-linked butyl rubber and exactly one depolymerised butyl rubber. Preferably, the adhesion-promoting layer includes at least one butyl rubber in an amount of at least about 23% by weight to about 60% by weight, more preferably in an amount in a range of about 25% by weight to about 53% by weight, in each case based on the total amount of the adhesion-promoting layer. Insofar as a mixture of an at least partially cross-linked butyl rubber with a non-cross-linked butyl rubber is provided, the cross-linked butyl rubber is present in an amount in a range from about 5% by weight to about 95% by weight, and the depolymerised butyl rubber is present in an amount in a range from about 95% by weight to about 5% by weight in such a mixture. Preferably, such a mixture includes exactly one of an at least partially cross-linked butyl rubber and a depolymerised butyl rubber, the at least partially cross-linked butyl rubber in an amount in a range from about 45% by weight to about 95% by weight, and the non-cross-linked butyl rubber in an amount in a range from about 5% by weight to about 55% by weight. More preferably, the ratio of the depolymerised butyl rubber to the at least partially cross-linked butyl rubber in a mixture of exactly one at least partially cross-linked butyl rubber and exactly one polymerised butyl rubber in the adhesion-promoting layer is in a range from about 1.1:1 to about 4:1.

Preferably, the at least one elastomer in the adhesion-promoting layer is an ethylene-propylene-diene rubber, preferably in an amount in a range from about 18% by weight to about 30% by weight, more preferably in a range from about 15% by weight to about 28% by weight (% by weight in each case based on the total amount of the adhesion-promoting layer), the diene of which is a 5-ethylidene-2-norbornene in an amount in a range from about 0.8% by weight to about 8% by weight, preferably in an amount in a range from about 1% by weight to about 7.5% by weight, still more preferably in an amount in a range from about 1.4% by weight to about 7% by weight, based on the total amount of monomers used in a polymerisation to the ethylene-propylene-diene rubber. Ethylene-propylene-diene rubbers that can be used in the bonding layer have already been described above with regard to their chemical and physical properties in connection with the formation of the at least one bonding layer of the bonding ply.

The adhesion-promoting layer may further include at least one additive selected from a group including tackifiers, antioxidants, catalysts, co-reagents and/or pigments. Pigments, in particular colour pigments, are particularly preferred. These can also be used, for example, in a master-batch with the at least one polymer. If the at least one polymer is used in the form of a master-batch, this preferably includes at least 80% by weight, based on the total amount of the master-batch, of the polymer, more preferably at least 85% by weight of the at least one polymer. A pigment, for example carbon black, is preferably included in an amount in a range from about 0.5% by weight to about 20% by weight, more preferably in an amount from about 1% by weight to about 15% by weight, of such a master-batch of the at least one polymer.

Hydrocarbon resins can be used as tackifiers, preferably in a range from about 0.5% by weight to about 10% by weight, more preferably in a range from about 1% by weight to about 5% by weight, in each case based on the total amount of the adhesion-promoting layer. If necessary, at least one antioxidant can also be added to the adhesion-promoting layer. Preferably, a mixture of different antioxidants is provided. The at least one antioxidant is present in an amount in a range from about 0.1% by weight to about 1% by weight, more preferably in an amount in a range from about 0.2% by weight to about 0.5% by weight, in each case based on the total amount of the adhesion-promoting layer. In particular, the antioxidants mentioned above in connection with the bonding layer can be used as possible antioxidants in the adhesion-promoting layer. The antioxidant is preferably tris(2,4-di-tert-butylphenyl) phosphite, or is selected from a group including sterically-inhibited phenols, such as pentacrythriol tetrakis (3-(3,5-di-ter-butyl-4-hydroxiphenyl) propionate). Organic bondings with zinc or tin, for example zinc stearates or zinc oleates, alone or in a mixture, are preferably used as catalysts. The catalysts, alone or in a mixture, are preferably present in an amount in a range from about 0.001% to about 10% by weight, preferably in a range from about 0.005% to about 4% by weight, in each case based on the total amount of the adhesion-promoting layer.

More preferably, the adhesion-promoting layer can include at least one co-reagent for the catalyst agent, selected from a group including triallyl cyanurate, triallyl isocyanurate, triallyl phosphate and/or divinylbenzene, and particularly preferably a triallyl cyanurate and/or a triallyl isocyanurate. The co-reagent serves in particular to make the catalysing agent used in the layer compatible. The adhesion-promoting layer advantageously includes the co-reagent in an amount in a range from about 0.01% by weight to about 5% by weight, more preferably in an amount in a range from about 0.2% by weight to about 5% by weight, preferably up to about 3% by weight, based on the total amount of the adhesion-promoting layer. A particularly preferred co-reagent is one from a group including triallyl cyanurate, triallyl isocyanurate and/or triallyl phosphate, especially preferably at least one triallyl cyanurate, wherein the above-mentioned co-reagents, used in an amount ranging from about 0.02% by weight to about 2% by weight, preferably in an amount in a range from about 0.025% to about 0.3% by weight, in each case based on the total amount of the adhesion-promoting layer, may be present in the layer.

Particularly preferred adhesion-promoting layers each have exactly one polyolefin, exactly one butyl rubber or exactly one polyisobutylene, depending on the material used for the at least one bonding layer of the at least one bonding ply, and exactly one elastomer. If the at least one bonding layer is formed from polyisobutylene, polyisobutylene is preferably also contained in the adhesion-promoting layer of the carrier facing this at least one bonding layer, if this is present. If the at least one bonding layer is formed from butyl rubber and polyisobutylene, the bonding layer of the carrier facing this at least one bonding layer, if present, preferably also contains butyl rubber and polyisobutylene. If the at least one bonding layer is formed from butyl rubber and polyisobutylene, the adhesion-promoting layer of the carrier facing this at least one bonding layer, if present, preferably also contains butyl rubber and polyisobutylene. If the at least one bonding layer is formed from butyl rubber, butyl rubber is preferably also contained in the bonding layer of the carrier facing this at least one bonding layer, if the latter is present. Particularly preferably, a polyethylene or a polypropylene, preferably in each case an electron-beam cross-linkable polyolefin, is used as exactly one polyolefin in the adhesion-promoting layer. A cross-linked butyl rubber, which can also be referred to as a pre-cross-linked butyl rubber, is preferably used as exactly one butyl rubber. Advantageously, an ethylene-propylene-diene rubber, particularly preferably one with 5-ethylidene-2-norbornene as a diene, is used as exactly one elastomer in the adhesion-promoting layer. A particularly preferred adhesion-promoting layer comprises about 22% by weight to about 55% by weight of a cross-linked butyl rubber, about 28% by weight to about 53% by weight of at least one, preferably electron-beam cross-linkable, polyethylene or polypropylene and about 12% by weight to about 30% by weight of an ethylene-propylene-diene rubber. % to about 30% by weight of an ethylene-propylene-diene rubber with 5-ethylidene-2-norbornene as a diene in an amount of about 1.5% to about 5% by weight, based on the monomers used in a polymerisation to the ethylene-propylene-diene rubber. The above weight percentages, with the exception of the diene, refer to the total amount of the adhesion-promoting layer.

The advantage of the adhesion-promoting layer is that it can act as such even at higher temperatures, for example when warm, or even hot, media flow through pipework or a pipeline, so that no detachment phenomena occur in the ply composite of bonding ply and carrier or carrier ply, and also provides sufficient mechanical strength. When the at least one electrically conductive material is arranged in the adhesion-promoting layer, good embedding of the conductive material can also be achieved due to its composition, in particular its chemical and/or physical properties, so that it is well and evenly embedded in the adhesion-promoting layer. The adhesion-promoting layer has good peel resistance, which can be determined in accordance with DIN EN 12068, version 1999-03, not only at elevated temperatures of 80° C. or higher, but also at room temperature, that is to say, 20° C. or 23° C. The aforementioned peel resistance refers to the mechanical peel test in accordance with DIN EN 12068, version 1999-03, in relation to both the application of an anti-corrosion tape with an adhesion-promoting layer on a factory sheathing of, for example, a pipe such as a gas pipe or pipeline, as well as in relation to an application on a non-sheathed pipe outer surface, for example a steel pipe.

The greatly improved peel resistance shows the very good mechanical strength that can be achieved with the adhesion-promoting layer in the inventive anti-corrosion tape. This also applies at higher temperatures, in particular at temperatures of 80° C. and above. In addition, the adhesion-promoting layer provides excellent adhesion to the carrier or the carrier layer, also in the form of an overstretch prevention layer. Furthermore, it is advantageous that due to the specific composition of the adhesion-promoting layer, when arranged on the carrier layer to form the carrier, it can be produced together with the carrier layer by a lamination process or a coextrusion process, preferably a coextrusion process, and, if necessary, can then be subjected to electron-beam cross-linking together with the carrier layer. Any disadvantageous depolymerisation of the butyl rubber or polyisobutylene caused by electron-beam cross-linking is compensated for by the use of the specific weight fractions and the addition of the at least one elastomer. As a result, it is ultimately possible to obtain carriers with an adhesion-promoting layer on one, preferably both, opposing first and second surfaces of the carrier layer, which have improved thermal and mechanical load-bearing capacity.

Due to these improved properties, anti-corrosion tapes in accordance with the disclosure provided with an adhesion promoting layer can be laid on pipes such as gas pipes or pipelines, depending on the embodiment, in particular with regard to the thickness of the carrier layer used, without these having to be bedded in sand after being provided with corrosion protection by the inventive anti-corrosion tape, wherein the sand also has to be brought in from outside the construction site concerned. Instead, for example, the excavated material can be used at the construction site, possibly after crushing by suitable crushers to produce certain soil qualities, for bedding the gas pipe or pipeline, for example. This can save considerable costs, both in terms of transport and storage of the sand and in terms of reduced environmental damage due to reduced movements of heavy equipment.

Preferably, the at least one anti-corrosion layer and/or the at least one bonding ply can fuse with an adhesion-promoting layer. In a form of embodiment in which the carrier includes at least one, preferably exactly one, carrier layer and two adhesion-promoting layers arranged on the two opposite surfaces of the carrier layer, and which includes an anti-corrosion ply and a bonding ply, wherein at least one adhesion-promoting layer is arranged exposed on one of the two surfaces of the carrier, the anti-corrosion ply of the anti-corrosion tape, which is turned towards an outer surface of the pipe or pipeline in the case of a spiral wrapping, for example of pipework or a pipeline, fuses with the exposed adhesion-promoting layer in the overlap area of the wrapping. After completion of the wrapping of the pipe or pipeline, a sheathing is formed on the pipe or pipeline after a certain period of time, which also depends on the temperature, due to the fusion properties of the bonding ply or anti-corrosion ply and the adhesion promoting layer. As a result, the inventive anti-corrosion tape makes the wrapped pipe or pipeline watertight and oxygen-tight. The pipe or pipeline is also protected against corrosion in the overlapping area due to the self-fusion.

Preferably, at least one electrically conductive material and/or at least one core material can be arranged in the at least one bonding ply and/or in the at least one anti-corrosion ply, and/or in at least one of the at least two carrier plies, preferably embedded or arranged on a surface of the latter. This achieves further functionalisation of the inventive anti-corrosion tape. Core materials within the meaning of the present disclosure are devices including transmitter-receiver systems, sensors, detectors, transducers and/or probes. The electrically conductive material or the core material is embedded in one of the aforementioned plies of the inventive anti-corrosion tape, or one of the layers of the latter if the material to be embedded is arranged within the ply or layer, that is to say, the material to be embedded is completely surrounded by the ply or layer, that is to say, the material of the ply or layer. Exceptions are the longitudinal edges and/or the end regions of the inventive anti-corrosion tape between the longitudinal edges or the end edges of the same, where the electrically conductive material to be embedded or the core material can lie open, that is to say, is not embedded on all sides. Examples of this are the addition of conductive carbon black or intrinsically conductive materials in powder form to the material of the said ply or layers of the latter, but also the provision of a non-perforated metal foil as a carrier layer and in particular the only layer in the carrier ply, which is then surrounded on one side by the bonding layer and on the other side by an anti-corrosion layer and is thus embedded. An electrically conductive material and/or a core material is also embedded if the material of the layer or the ply, in particular butyl rubber and/or polyisobutylene, in particular the bonding ply and/or the anti-corrosion ply, protrudes through recesses, holes or perforations arranged in the electrically conductive material and/or core material, thereby integrating the material to be embedded with the layer or the ply, in particular butyl rubber and/or polyisobutylenc. Examples of this are a design of the carrier of the carrier ply as a metal grid or as a metal grid or metal knitted fabric, or as a perforated metal foil, which then form a single-layer carrier ply. It is not necessary to completely surround the material to be embedded with the material of the layer, but this can be done. What is relevant is the creation of a sufficient bond between the material to be embedded, particularly if it has recesses or openings, and the material of the layer or ply. This is done in order to avoid delamination of the material to be embedded from the layer or ply, in particular butyl rubber and/or polyisobutylenc.

The conductivity of a material or material mixture depends on the availability and density of mobile charge carriers. These can be loosely bound electrons, such as in metals, but also ions or delocalised electrons in organic molecules, as often described by mesomeric boundary structures. Substances with freely movable charge carriers are conductive. The advantage of providing the conductive material in the inventive anti-corrosion tape is that current can be conducted in the pipe wrapped with the inventive anti-corrosion tape, for example, up to a point that is damaged, in particular also in an overlap region, especially in the case of spiral wrapping, which often has no contact with the pipe in the region between a lower anti-corrosion layer of the upper winding and an upper anti-corrosion layer or carrier layer of the previous winding and is therefore susceptible to spiral corrosion despite the passive protective device. Spiral corrosion is thus reliably prevented. Preferably, an electrically conductive material is embedded in at least one ply, preferably exactly one ply. It is further preferred that an electrically conductive material is embedded in at least two plies. The electrically conductive material provides a second barrier against corrosion.

Preferably, the electrically conductive material is selected from a group including metals, conductive polymers and/or carbon. The electrically conductive material is more preferably selected from a group including metals and/or conductive polymers. Metals are electron conductors whose electrons in the conduction band are mobile and transport electrical current excellently. The electrical conductivity of metals is preferably in a range between about 0.5*10⁶ S/m and about 100*10⁶ S/m at room temperature. Conductive polymers, especially intrinsically conductive polymers, are plastics with electrical conductivity. The conductivity of the polymer is achieved by conjugated double bonds and/or doping, which allow charge carriers to move freely in the doped state. The electrical conductivity of conductive polymers is preferably in a range between about 10⁻⁵ S/m and about 10⁵ S/m at room temperature (20° C.). Carbon can be used in the form of fibres, but as a powder or as particles, also in platelet form, in the form of graphite or graphene, in particular as an additive to the plastic materials intended for the carrier layer. The advantage of using platelet-shaped or particulate electrically conductive materials such as carbon (graphite or graphene) lies in the fact that a uniform distribution can be achieved in at least one ply of the anti-corrosion tape.

The electrically conductive material is preferably arranged over a large area or part of the surface of the anti-corrosion tape. The probability that a conductive material with a large or partial surface area will be located in the region of the damage or damaged area in the event of damage is greater than with a unidirectional material, for example a wire-shaped material such as a metal wire that can also be used. The sheathed pipe is favourably protected against corrosion with an electrically conductive material that can be arranged over a large area.

The electrically conductive material is preferably in the form of powders, particles, strips, wires, fabrics, nets, scrims, knitted fabrics, non-wovens or in the form of metallic or metallised, preferably perforated, films. If the electrically conductive material is present in the form of woven fabrics, nets, fabrics, knitted fabrics, non-woven fabrics or in the form of metallic or metallised, preferably perforated, films, it can form the carrier ply, or at least one layer of the carrier of a carrier ply, preferably the carrier layer, and more preferably forms the carrier ply alone.

The electrically conductive material is particularly preferably a fabric, even more preferably a hybrid fabric, including conductive and non-conductive materials. This is preferably formed as a carrier layer of the carrier ply and more preferably forms the carrier ply alone. Preferably, a first material of the fabric is selected from a group including at least one polyamide and/or polyester fibre materials, and is preferably a polyester. The first material is preferably designed in the form of a yarn. Preferably, a second material of the fabric is selected from a group including conductive metals, in particular stainless steel and/or copper and/or bronze. It is also preferably designed in the form of a yarn or a wire. Preferably, a thickness (diameter) of the first material is in a range between about 0.003 mm and about 0.30 mm. Preferably, the second material has the form of a corrugated, yarn-like wire. Preferably, the second material is a stainless steel wire and/or a copper wire and/or a bronze wire in the case of a wire-like design, or a design as a wire. If stainless steel is used as the second material, this is preferably a material 1.4301 in accordance with DIN EN 10088-3. Preferably, a thickness (diameter) of the second material is in a range between about 0.003 mm and about 0.30 mm. Preferably, a corrugated shape of the wire and/or the method of weaving with the first, yarn-like material enable the fabric to adapt to the shape of the pipe when wrapped with the inventive anti-corrosion tape under tension. Preferably, the first yarn-like material is arranged in the longitudinal direction and the second yarn-like material is arranged in the transverse direction of the inventive anti-corrosion tape. A third material is preferably provided. The third material can be identical to the second material and is preferably made of stainless steel and/or copper and/or bronze. Preferably, a thickness (diameter) of the third material is in a range between about 0.003 mm and about 0.30 mm. Preferably, the first yarn-like material is arranged alternately with the third yarn-like material in the longitudinal direction and the second yarn-like material in the transverse direction of the inventive anti-corrosion tape. In the longitudinal direction, the first yarn-like material and the third yarn-like material are preferably arranged at a distance of about 0.2 mm to about 3 cm, preferably between about 0.3 mm and about 2.2 cm. Preferably, the first material is a first warp yarn. Preferably, the second material is a weft yarn. A warp yarn is a thread that is stretched lengthwise in a loom in a weaving mill. In the finished fabric, the warp yarns lie parallel to the selvedge, while weft yarns run transversely to it. Preferably, the third material is a second warp yarn. The first and second warp yarns are preferably arranged alternately in the fabric. The fabric preferably has a plain weave, but can also have a twill weave. A stitch of a woven fabric, preferably a hybrid woven fabric, is preferably rectangular or square. A stitch is a loop of wire that is created during knitting or crocheting or by linking. Preferably, the size of a rectangular, in particular square, stitch of the hybrid fabric is in a range between approximately 0.3 mm×0.3 mm and approximately 3.0 mm×3.0 mm.

Preferably, a suitable fabric has a permeability value in accordance with DIN 18130 of between about 10⁻⁸ and about 10⁻² m/s, more preferably between about 10⁻⁶ and about 10⁻³ m/s, particularly preferably between about 10⁻⁵ and about 104 m/s. More preferably, the fabric has a grid size in accordance with DIN ISO 9044:2017-11 between about 0.005 mm to about 50 mm, more preferably between about 0.01 mm to about 10 mm, particularly preferably between about 0.05 mm to about 5 mm, more preferably in a range from about 0.2 mm to about 3 mm, and even more preferably in a range from about 0.4 mm to about 2 mm. The grid size is the distance between two neighbouring warp or weft yarns.

The electrically conductive material is preferably in the form of metallised foil or in the form of a metal foil. The metallised foil can be a rescue foil, for example. A metallised foil is, for example, a plastic foil vaporised with a metallic material. A metallised foil consists only of metal. The foil, regardless of its design, preferably has recesses, for example in the form of a perforation, in order to ensure embedding with the material of the anti-corrosion ply and/or bonding ply and/or an adjacent carrier ply. The foil is preferably perforated. The perforation is preferably circular in shape. The perforation is preferably over the entire surface, but can also be formed over part of the surface of the foil. In the bonding ply, the foil can be embedded in the material of the bonding ply or arranged on the first and/or second surface of the bonding ply, on the inside between the carrier and bonding plies. Perforated metallic or metallised films as a carrier layer preferably form a single-layer carrier. Films filled with metallic particles can also be provided, for example made of polyethylene with conductive carbon black incorporated in it, or in the form of mixtures of polyethylene with the addition of conductive intrinsic polymers. Conductive films can be coextruded together with adhesion-promoting layers on both surfaces of the foil serving as a carrier layer, thus forming a carrier ply. At least one adhesion-promoting layer of a carrier ply can also be conductive, as described above for the carrier layer. When manufactured in coextrusion with the carrier layer, only the carrier layer, only the at least one or preferably both adhesion-promoting layers in the case of coextrusion with two adhesion-promoting layers, or both the carrier layer and at least one or both adhesion-promoting layers can be electrically conductive, for example.

Preferably the electrically conductive material is present filled in polymers. Carbon black, a form of carbon, or powder of conductive metals can be used as the electrically conductive material, preferably as a batch with an elastomer, preferably polyethylene, polypropylene, butyl rubber, polyisobutylene or a thermoplastic elastomer. It is preferably added to the material from which the bonding layer, the anti-corrosion layer or the carrier layer, in particular the carrier layer, are produced, in powder form or in particle form, also in flake form (as a pure form or batch). The addition of conductive materials consisting of metal powders, carbon black or similar is not required, or can be omitted if intrinsically conductive polymers are used.

Preferably, the electrically conductive material provides a conductivity between the first and second longitudinal edges of the anti-corrosion tape. The current can be transported from one longitudinal edge to the other. For example, after pipework or a pipeline has been wrapped and fused, the inventive anti-corrosion tape forms a continuous sheathing on the pipe or pipeline. An electric current can be transmitted externally through the sheathing from one end of the pipe to the other end, even in the overlapping regions created during wrapping, so that spiral corrosion is reliably prevented in the event of damage. In particular, spiral corrosion is also advantageously prevented in regions that are further away from the damage.

In the event of damage to a sheathing made from the anti-corrosion tape, the electrically conductive material preferably provides conductivity at one edge of the damage so that an electric current can be conducted to the damaged region as the location of the damage. In this way, sufficient electrons can be provided to prevent corrosion. The pH value in the vicinity of the damaged region becomes alkaline and thus protects the damaged region, even if the sheathing should peel off in this region.

Preferably, the electrically conductive material is arranged essentially non-elastically in a transverse direction, defined by a shortest connection between the first and the second longitudinal edge of the anti-corrosion tape, in at least one layer of the inventive anti-corrosion tape. The conductive material preferably extends over the entire width of the material between the first longitudinal edge and the second longitudinal edge. The advantage is that the current can be safely conducted from a first longitudinal edge of the anti-corrosion tape to the second longitudinal edge. In a direction perpendicular to the transverse direction in the anti-corrosion tape from the beginning to the end of the tape, that is to say, in the longitudinal direction, the conductive material as defined above is preferably essentially clastic, or is designed in such a way that it does not tear due to the tensile forces acting on the tape during winding. This can be achieved, for example, by a corrugated form of the conductive material, in particular a woven fabric, or by the provision of loops in the latter, in particular in the case of woven and knitted fabrics. The conductive material preferably extends over the entire length of the material. The anti-corrosion tape itself is preferably essentially clastic in a longitudinal direction. The length of the anti-corrosion tape can increase under tensile load.

An additional advantage of the conductivity of the anti-corrosion tape in the transverse and/or longitudinal direction of the anti-corrosion tape, which is also guaranteed in the absence of water, is that corrosion protection is possible even if, for example, the soil in individual sections along a pipeline has already dried. A current ingress, even if it occurs at a more distant location, can reach the affected region with the longitudinal line in the tape along a centre line of a pipe, such as a pipeline. This is particularly advantageous if pipework or a pipeline is completely wrapped over its entire length or at least a certain length of the pipe or pipeline. Even if only one weld seam, for example of a pipeline, is sheathed with the inventive anti-corrosion tape, the damaged region could be at the upper apex of the pipe and the current could enter at the bottom of the pipe, for example, if sufficient conductivity of the environment is not guaranteed at the top of the pipe. The supplementary anti-corrosion function of the inventive anti-corrosion tape is also ensured in such a case by the at least one electrically conductive material arranged in the latter.

Preferably, the electrically conductive materials are arranged in the form of fabrics, nets, scrims, knitted fabrics, non-woven fabrics or metallic or metallised, preferably perforated, films embedded in the transverse direction of the anti-corrosion tape, and/or in the longitudinal direction of the anti-corrosion tape in the at least one bonding ply and/or the at least one anti-corrosion ply, and/or on at least one surface of the at least one bonding ply and/or the at least one anti-corrosion ply.

Preferably, the electrically conductive material is essentially completely surrounded by the material of the bonding ply, the carrier ply, in particular the carrier layer and/or the adhesion-promoting layer, and/or the anti-corrosion layer, except for regions on the first and on the second longitudinal edge of the anti-corrosion tape opposite the first longitudinal edge. Preferably, the electrically conductive material is essentially completely surrounded by the material of the at least one bonding ply and/or the anti-corrosion ply, except for regions on the first and second longitudinal edges. In this way, the conductive material is protected and is not itself corroded.

Preferably, at least one core material is arranged, preferably embedded, in the at least one bonding ply, in at least one of the at least two carrier plies, and/or in the at least one anti-corrosion ply. Core materials include devices that enable automatic and contactless identification and localisation of target variables. The core material includes RFID systems (RFID means radio frequency identification), a technology for transmitter-receiver systems with radio waves, sensors, detectors, transducers and/or feelers. The latter devices in particular can record chemical or physical properties qualitatively or quantitatively as a measured variable. The data recorded by the devices can be converted into a further processed signal and made available for further processing, for example to detect and/or localise defects in a pipeline, such as a weld seam.

The present disclosure also relates to a method for applying the inventive anti-corrosion tape as corrosion protection to constituent parts, in particular pipes, pipelines, tubular objects, pipelines and pipeline constituent parts, tanks and constituent parts of tanks, as well as to other systems and installations by the application of the anti-corrosion tape to the latter. A pipe is a cylindrical hollow body that is primarily used to transport gases, liquids and/or solids. A pipe can be, for example, a pipe of a water pipeline or a district heating system or a pipeline, for example, for oil, gases and/or chemical substances. Constituent parts of tanks are, for example, tank bottoms, metal containers, fittings and tank connections.

In a particularly preferred method for the application of the inventive anti-corrosion tape, constituent parts such as pipes, pipelines, tubular objects, pipelines and pipeline constituent parts as well as tanks are wrapped with the inventive anti-corrosion tape. The inventive anti-corrosion tape renders superfluous a second or further wrapping or covering of constituent parts such as, in particular, pipes, pipelines, tubular objects, pipelines and pipeline constituent parts and tanks with additional protection, for example in the form of a protective tape or a protective mat. The inventive anti-corrosion tape renders unnecessary the provision of, or wrapping with, additional mechanical protection. By wrapping pipes or systems including pipes with the inventive anti-corrosion tape, including at least four plies, the at least one first and at least one second wrapping known from the prior art, which therefore requires two operations, can be omitted, and just a single wrapping can be carried out in one operation. The second wrapping in accordance with the prior art is carried out either again with the same or a similar anti-corrosion tape or with a mechanical protection tape.

The present disclosure further relates to a method for the production of the inventive anti-corrosion tape as defined above in various forms of embodiment by the application of pressure to at least one first, at least two-ply, anti-corrosion tape, and to at least one second, at least two-ply, anti-corrosion tape, wherein the first and the second anti-corrosion tape include at least one carrier ply and at least one anti-corrosion ply, such that the first or the second anti-corrosion tape is brought into contact with the respectively other anti-corrosion tape so that at least one anti-corrosion ply of the first or the second anti-corrosion tape forms a bonding ply arranged between the carrier plies, that the first or the second anti-corrosion tape is brought into contact with the respective other anti-corrosion tape, so that at least one anti-corrosion ply of the first or of the second anti-corrosion tape forms a bonding ply, arranged between the carrier plies of the at least one first and second anti-corrosion tape, and the at least one other anti-corrosion ply of the first or second anti-corrosion tape forms an outer ply of the anti-corrosion tape. Preferably, a direct contact takes place between the bonding ply of the first or second anti-corrosion tape and the carrier ply of the other anti-corrosion tape. The contact between the bonding ply of the first or second anti-corrosion tape and the carrier ply of the other anti-corrosion tape is preferably made without a primer, or one or a plurality of additional plies. Preferably, at least one first, at least two-ply, anti-corrosion tape and at least one second, at least two-ply, anti-corrosion tape are used to produce the inventive anti-corrosion tape. The first and the second anti-corrosion tape include at least one carrier ply and at least one anti-corrosion ply. To produce the inventive anti-corrosion tape, the first anti-corrosion tape and the second anti-corrosion tape are brought into contact in such a way that the anti-corrosion ply of the first or second anti-corrosion tape is brought into contact with the carrier ply of the respectively other anti-corrosion tape. By bringing the first and second anti-corrosion tapes into contact, or subsequently bringing them into contact, a bonding ply is formed from the respective anti-corrosion ply of the first and second anti-corrosion tapes by the exertion of pressure, which bonding ply is arranged between the carrier ply of the first anti-corrosion tape and the carrier ply of the second anti-corrosion tape. The first and second anti-corrosion tapes can be brought into contact with at least one carrier ply and at least one anti-corrosion ply before, or at the same time as, pressure is applied to the first and second anti-corrosion tapes. This can take place simultaneously, for example, when the first and second anti-corrosion tapes are fed separately into a roll gap in a calendar. In the product manufactured in this way the other anti-corrosion ply serves as an anti-corrosion ply of the inventive anti-corrosion tape. In the context of the present disclosure, anti-corrosion tapes are configured in the form of tapes, mats, or another flat design. The present disclosure also includes tapes, mats, or webs, which can be cut to a desired width of the anti-corrosion tape as required. Preferably, webs are used for the production of the anti-corrosion tapes, preferably with a width of up to 6 m, more preferably with a width of up to 3.5 m.

The bonding ply is used to bond the carrier plies to each other, but also in order to be able to functionalise the anti-corrosion tape easily so that the anti-corrosion tape has additional properties. The bonding ply can optionally provide electrical conductivity. This can also be achieved, for example, by applying an electrically conductive material to a surface of the at least one anti-corrosion ply of the first anti-corrosion tape, which is arranged opposite a surface of the at least one anti-corrosion ply of the second anti-corrosion tape, or a surface of the at least one carrier layer, before bringing the first and second anti-corrosion tapes into contact in accordance with the inventive method. The electrically conductive material can be, for example, a conductive carbon black powder, or a metal powder, or a metallic or metallised foil, preferably perforated. The conductivity can be provided over the entire length of the tape or at least in some sections. An electrically conductive material is preferably embedded in at least one bonding ply. Preferably selected electrically conductive materials have already been described in connection with the design of the electrical conductivity of the bonding ply and/or the anti-corrosion ply. The core materials optionally embedded in the bonding ply and/or anti-corrosion ply have also already been described above in connection with the design of the electrical conductivity. Furthermore, the bonding ply is used to adjust easily different material properties of the various plies of the anti-corrosion tape. For example, the bonding ply can have material properties that differ from those of the anti-corrosion ply of the at least four-ply inventive anti-corrosion tape. This can easily be achieved in the inventive method by adjusting the properties of the anti-corrosion plies of the first and second anti-corrosion tapes in a different manner. Preferably, the viscosity and strength of the bonding ply and the anti-corrosion ply in the at least four-ply inventive anti-corrosion tape can thus be adjusted in different manners. Thus, the bonding ply preferably has a lower viscosity and/or a lower strength than the anti-corrosion ply.

Preferably, the at least one first, at least two-ply anti-corrosion tape and the at least one second, at least two-ply anti-corrosion tape are pressed together by a pressing process. In the context of the present disclosure, pressing processes are understood to mean methods that plastically deform a material to be pressed under the action of external forces, wherein a specific change in the external shape of the material to be pressed is brought about. Preferably, the at least one first and the at least one second anti-corrosion tape are pressed together. Preferably, a pressing process is used in the present disclosure that essentially exerts an external force on a cross-sectional area of an anti-corrosion tape. The cross-sectional area of an anti-corrosion tape is defined as the area defined by the width and the thickness of the anti-corrosion tape. Preferably, the external force is transmitted to an anti-corrosion tape by means of at least one roller. In the context of the present disclosure, the term pressure is used as a synonym for the force transmitted to an anti-corrosion tape via the roller. More preferably, the pressure is transmitted by means of at least two rollers, preferably a top roller and a bottom roller, which are each in contact with the at least first anti-corrosion tape and with the at least second anti-corrosion tape. The top roller and the bottom roller define a nip associated with a region formed between the top roller and the bottom roller. The at least one first and the at least one second anti-corrosion tape enter the roll gap and are pressed together after passing through the roll gap. The pressed-together anti-corrosion tape emerging from the roll gap is an at least four-ply inventive anti-corrosion tape. More preferably, the pressure is transmitted by means of one, two, three or a plurality of rollers, wherein the rollers can act as a working roller or a supporting roller for the working roller. A system of a plurality of rollers lying on top of each other is also conceivable as a pressing process. It is also conceivable that the at least one first anti-corrosion tape and the at least one second anti-corrosion tape, which enter the roll gap, or the at least four-ply anti-corrosion tape formed after passing through a first roll gap in accordance with the disclosure, pass through two, three or a plurality of roll gaps. It is also conceivable that a rolling system in the form of a calendering process is used. Preferably, a roll with a rubber coating and a steel roll as a supporting roll are used in the calendering process. Preferably, the roll gap has a gap of 0.5 mm to 1.5 mm, more preferably of 0.7 mm to 1.3 mm. Preferably, the pressing process includes a stretching of the at least one first anti-corrosion tape, the at least one second anti-corrosion tape, and/or the inventive anti-corrosion tape formed thereby. In the context of the present disclosure, stretching includes an externally applied force in the longitudinal direction of an anti-corrosion tape. Preferably, the force acting from the outside during stretching is a tensile force which pulls an anti-corrosion tape in the longitudinal direction. In particular, stretching can take place after the pressure is exerted on the inventive anti-corrosion tape then formed, for example in connection with the winding of the web-form product forming the inventive anti-corrosion tape.

The thickness or depth of the inventive anti-corrosion tape can be varied by a specific adjustment of the rolling gap, the pressure of the rollers, the stretching or other process variables relating to the pressing process or the winding. The thickness or depth of the bonding layer or the design of the bonding layer relating to electrically conductive materials and/or core materials can also be varied by a specific adjustment of the roll gap, the pressure of the rollers, the stretching or other process variables relating to the pressing process or the winding.

In a particularly preferred form of embodiment for the production of the inventive anti-corrosion tape, the first anti-corrosion tape includes two plies and the second anti-corrosion tape includes three plies. Here the first anti-corrosion tape includes a carrier ply and an anti-corrosion ply. The second anti-corrosion tape includes a carrier ply and two anti-corrosion plies in such a way that the carrier layer is arranged between the first and the second anti-corrosion ply. For the production of the inventive anti-corrosion tape, the first anti-corrosion tape and the second anti-corrosion tape are brought into contact in such a way that the anti-corrosion layer of the first anti-corrosion tape is brought into contact with one of the two anti-corrosion plies of the second anti-corrosion tape. By bringing the first and second anti-corrosion tapes into contact, the two anti-corrosion plies of the first and second anti-corrosion tapes form a bonding ply after pressure is applied, which is arranged between the carrier ply of the first anti-corrosion tape and the carrier ply of the second anti-corrosion tape. This nevertheless results in a four-ply inventive anti-corrosion tape, as the two anti-corrosion plies of the first and second anti-corrosion tapes that come into contact form a single-ply bonding layer when pressure is applied. This is aided by heating when the pressure is exerted, for example by using temperature-controlled rollers, which is generally preferred in the inventive method. Temperatures in a range from about 25° C. to about 170° C., preferably in a range from about 30° C. to about 140° C., are preferably used.

Preferably, the carrier ply of the at least one first and/or of the at least one second anti-corrosion tape is formed from an at least single-ply carrier, wherein at least one layer of the carrier is formed as a carrier layer, wherein the carrier layer is formed from at least one carrier material selected from a group including polyethylene, polypropylene, polyvinyl chloride, thermoplastic elastomers and/or metals, preferably such as described above. Preferably, a material selected from a group including at least one butyl rubber and/or at least one polyisobutylene, preferably such as described further above, is used for the at least one anti-corrosion ply of the at least one first and/or the at least one second anti-corrosion tape. Preferably, the at least one first, at least two-ply anti-corrosion tape and the at least one second, at least two-ply anti-corrosion tape are pressed together by a pressing process as explained above.

In a further preferred form of embodiment for the production of the inventive anti-corrosion tape, the first anti-corrosion tape includes three plies and the second anti-corrosion tape includes three plies. The first and the second anti-corrosion tape each include a carrier ply and two anti-corrosion plies, wherein the carrier ply is arranged between the first and the second anti-corrosion ply of the respective anti-corrosion tape. To produce the inventive anti-corrosion tape, the first anti-corrosion tape and the second anti-corrosion tape are brought into contact in such a way that one of the two anti-corrosion plies of the first anti-corrosion tape is brought into contact with one of the two anti-corrosion plies of the second anti-corrosion tape. By bringing the first and second anti-corrosion tapes into contact, the two anti-corrosion plies of the first and second anti-corrosion tapes form a bonding ply after pressure is applied, which is arranged between the carrier ply of the first anti-corrosion tape and the carrier ply of the second anti-corrosion tape. Preferably, the first three-ply anti-corrosion tape and the second three-ply anti-corrosion tape are pressed together by a pressing process already explained above. This results in a five-ply inventive anti-corrosion tape, as the two anti-corrosion plies of the first and second anti-corrosion tapes that come into contact form a single-ply bonding layer by exerting pressure. Here too, the formation of the bonding layer can be assisted by heating, as described above.

The present disclosure further relates to the use of the inventive anti-corrosion tape for the protection of constituent parts, in particular pipes, pipelines, tubular objects, pipelines and pipeline constituent parts as well as tanks and constituent parts of tanks and other installations and fixtures, against corrosion. Particularly preferred is the use of the anti-corrosion tape in the method for applying the inventive anti-corrosion tape as described above.

The present disclosure also relates to the use of the inventive anti-corrosion tape for localising at least one defect in pipework or a pipeline in the region of a weld seam, wherein the bonding ply includes at least one conductive material and/or core material embedded in the at least one bonding ply, which can be arranged at least in the region of a weld seam of pipework or a pipeline. Preferably, the anti-corrosion tape for localising at least one defect in pipework or a pipeline in the region of a weld seam includes at least one anti-corrosion ply including a material selected from a group including at least one butyl rubber and/or at least one polyisobutylene. More preferably, the anti-corrosion layer includes at least one conductive material and/or core material embedded in the at least one anti-corrosion layer. Preferably, the anti-corrosion tape for localising at least one defect in pipework or a pipeline in the region of a weld seam includes a carrier layer of at least one carrier ply, which is formed from at least one carrier material selected from a group including polyethylene, polypropylene, polyvinyl chloride, thermoplastic elastomers and/or metals. More preferably, the anti-corrosion tape for localising at least one defect in pipework or a pipeline in the region of a weld seam includes carrier layers in the at least two carrier plies, which are formed from at least one carrier material selected from a group including polyethylene, polypropylene, polyvinyl chloride, thermoplastic elastomers and/or metals. Particularly preferably, the anti-corrosion tape includes two identical carrier layers for localising at least one defect in pipework or a pipeline in the area of a weld seam. Preferably, an adhesion-promoting layer is arranged on at least one surface of the carrier layer of at least one of the carrier plies. Preferably, adhesion-promoting layers are arranged on at least one surface of the carrier layers of the carrier plies.

The present disclosure is explained in more detail with reference to the following examples.

It should be emphasised at this point that the features given in the examples can be combined with all the features described individually or with each other in the general description.

A first, two-ply anti-corrosion tape and a second, three-ply anti-corrosion tape were used to produce an anti-corrosion tape. The first, two-ply anti-corrosion tape was formed with a three-layer carrier ply, wherein the carrier ply was configured as a carrier layer with adhesion-promoting layers applied to both opposing surfaces of the same. The carrier layer of the carrier ply consisted of polyethylene. The adhesion-promoting layer consisted of 50% by weight of an at least partially pre-cross-linked butyl rubber having the properties specified in the above description, 33.33% by weight of an electron-beam cross-linkable polyethylene, and 16.67% by weight of an ethylene-propylene-diene rubber with 5-ethylidene-2-norbornene as a dienc, wherein the amounts are based on the total amount of the adhesion-promoting layer, and the constituent parts have properties as specified in the above description. In a coextrusion method, the carrier ply was produced with a carrier layer and adhesion-promoting layers arranged on the two surfaces of the carrier layer. The carrier layer had a thickness of 0.5 mm and the adhesion-promoting layers each had a thickness of 40 μm.

The second ply of the first, two-layer anti-corrosion tape was confiugred as an anti-corrosion ply, which was produced from 30% by weight of a polyisobutylene. 10% by weight of a butyl rubber, 60% by weight of a powdered, mineral filler material, in each case based on the total amount of the anti-corrosion ply. The constituent parts of the anti-corrosion ply have properties as specified in the above description. The anti-corrosion ply was arranged on a surface of the carrier ply, adjacent to one of the two adhesion-promoting layers.

The second, three-ply anti-corrosion tape was formed with a three-layer carrier ply, wherein the carrier ply was a carrier layer with an adhesion-promoting layer applied to both surfaces of the same. The carrier layer of the carrier ply consisted of polyethylene. The adhesion-promoting layer consisted of 50% by weight of an at least partially pre-cross-linked butyl rubber with the properties specified in the above description. 33.33% by weight of an electron-beam cross-linkable polyethylene, and 16.67% by weight of an ethylene-propylene-diene rubber, with 5-ethylidene-2-norbornene as a diene, wherein the amounts are based on the total amount of the adhesion-promoting layer, and the constituent parts have properties as specified in the above description. In a coextrusion method, the carrier ply was produced with a carrier layer and adhesion-promoting layers arranged on the two surfaces of the carrier layer. The carrier layer had a thickness or depth of 0.5 mm and the adhesion-promoting layers each had a thickness of 40 μm. The second and third plies of the second three-ply anti-corrosion tape were configured as anti-corrosion plies. These two anti-corrosion plies were each arranged on a surface of the carrier ply in such a way that the carrier ply was arranged between the two anti-corrosion plies. The two anti-corrosion plies consisted of 30% by weight of a polyisobutylene, 10% by weight of a butyl rubber and 60% by weight of a powdered mineral filler material, each based on the total amount of the anti-corrosion ply. The constituent parts of the anti-corrosion ply have properties as specified in the above description. One of the two anti-corrosion plies also included a flat, circularly perforated metallised rescue foil, which was embedded in one of the two anti-corrosion plies.

The first two-ply and the second three-ply were pressed in a calendering process with a rubber-coated work roll and a counter roll made of steel. The roll gap was set to 0.9 mm. The emerging pressed anti-corrosion tape was also subjected to stretching. The two incoming anti-corrosion tapes were placed on top of each other for pressing in such a way that the carrier ply of the first two-ply anti-corrosion tape was in contact with the anti-corrosion ply with the embedded electrically conductive material of the second anti-corrosion tape. The pressed outgoing anti-corrosion tape formed a bonding ply with embedded electrically conductive material in the form of a metallised, perforated rescue foil between the carrier ply of the first tape and the carrier ply of the second tape.

An alternative, second example of a production of an anti-corrosion tape includes the provision of a first, three-ply anti-corrosion tape and a second, three-ply anti-corrosion tape. The first, three-ply anti-corrosion tape was formed with a three-layer carrier ply which was formed like the carrier ply of the first anti-corrosion tape of the first example above. The second ply and the third ply of the first three-ply anti-corrosion tape were designed as an anti-corrosion ply, which was designed like the anti-corrosion ply of the first anti-corrosion tape from the first example above. The two anti-corrosion plies were each arranged on a surface of the carrier ply, adjacent to one of the two adhesion-promoting plies, in such a way that the carrier ply was arranged between the two anti-corrosion plies.

The second, three-ply anti-corrosion tape was designed with a three-layer carrier ply, wherein the carrier ply was designed like the carrier ply of the first anti-corrosion tape of the first example above. The second and third plies of the second, three-ply anti-corrosion tape were designed as anti-corrosion plies. The two anti-corrosion plies were each arranged on a surface of the carrier ply in such a way that the carrier ply was arranged between the two anti-corrosion plies. The two anti-corrosion plies consisted of 30% by weight of a polyisobutylene. 10% by weight of a butyl rubber and 60% by weight of a powdered mineral filler material, each based on the total amount of the anti-corrosion layer. The constituent parts of the anti-corrosion ply have properties as described above. The second ply of the two anti-corrosion plies also included an RFID system, wherein RFID transponders were embedded in sections of the second anti-corrosion ply in such a way that at least one RFID transponder was available in 15 cm sections along the entire length of the anti-corrosion tape.

The first three-ply and the second three-ply tape were pressed in a calendering process with a rubber-coated work roll and a counter roll made of steel. The roll gap was set to 1.0 mm. The pressed anti-corrosion tape emerging from the roll gap was also subjected to stretching. The two anti-corrosion tapes entering the rolling gap were placed on top of each other for pressing, in such a way that an anti-corrosion ply of the first three-ply anti-corrosion tape came into contact with the anti-corrosion ply with the embedded electrically conductive material of the second three-ply anti-corrosion tape. The pressed emerging five-ply anti-corrosion tape thus formed a bonding ply between the carrier ply of the first tape and the carrier ply of the second tape, consisting of two anti-corrosion plies, wherein the RFID transponder is embedded in the bonding ply.

An alternative, third example of the production of an anti-corrosion tape includes the provision of a first, three-ply anti-corrosion tape and a second, two-ply anti-corrosion tape. The first, three-ply anti-corrosion tape was formed with a three-layer carrier ply, which like the carrier ply of the first anti-corrosion tape was formed from the first example above. The second and third plies of the first three-ply anti-corrosion tape were designed as anti-corrosion plies, which were designed like the anti-corrosion ply of the first anti-corrosion tape from the first example above. The two anti-corrosion plies were each arranged on a surface of the carrier ply, adjacent to one of the two adhesion-promoting plies, such that the carrier ply was arranged between the two anti-corrosion plies.

The second, two-ply anti-corrosion tape was designed with a single-layer carrier ply, wherein the only layer of the carrier ply was a carrier layer. The carrier layer was designed in the form of a grid, wherein the carrier material consisted of stainless steel wire and copper wire and was therefore electrically conductive. The carrier layer had a thickness of 0.7 mm.

The second ply of the first, two-ply anti-corrosion tape was designed as an anti-corrosion ply, which was produced from 30% by weight of a polyisobutylenc. 10% by weight of a butyl rubber, 60% by weight of a powdered, mineral filler material, in each case based on the total amount of the anti-corrosion ply. The constituent parts of the anti-corrosion ply have properties as specified in the above description. The anti-corrosion ply was arranged on a surface of the carrier ply, adjacent to the adhesion-promoting layer.

The first, three-ply tape and the second, two-ply tape were pressed in a calendering process with a rubber-coated work roll and a counter roll made of steel. The roll gap was set to 1.0 mm. The two anti-corrosion tapes entering the roll gap were placed on top of each other for pressing in such a way that one anti-corrosion ply of the first three-ply anti-corrosion tape came into contact with the metal grid carrier ply of the second anti-corrosion tape. The pressed emerging five-ply anti-corrosion tape thus formed a bonding ply consisting of only one anti-corrosion ply of the first three-ply anti-corrosion tape between the carrier ply of the first tape and the electrically conductive carrier ply of the second tape.

An alternative, fourth example of the production of an anti-corrosion tape includes the provision of a first, three-ply anti-corrosion tape and a second, three-ply anti-corrosion tape. The first, three-ply anti-corrosion tape was formed with a three-layer carrier ply, wherein the carrier ply was a carrier layer with an adhesion-promoting layer applied to both surfaces of the latter. The adhesion-promoting layers consisted of 50% by weight of an at least partially pre-cross-linked butyl rubber with the properties specified in the above description, 33.33% by weight of a thermoplastic elastomer TPS-SEBS, and 16.67% by weight of an ethylene-propylene-diene rubber, with 5-ethylidene-2-norbornene as a diene, wherein the amounts are based on the total amount of the adhesion-promoting layer, and the constituent parts have properties as specified in the above description. The carrier layer consisted of a thermoplastic elastomer, namely TPS-SEBS. In a coextrusion method, the carrier ply was produced with a carrier layer and adhesion-promoting plies arranged on the two surfaces of the carrier layer. The carrier layer had a thickness of 0.5 mm and the adhesion-promoting plies each had a thickness of 40 μm.

The first three-ply anti-corrosion tape had two anti-corrosion plies, each of which was arranged on a surface of the carrier ply in such a way that the carrier ply was arranged be-tween the two anti-corrosion plies. The two anti-corrosion plies consisted of 30% by weight of a polyisobutylenc. 10% by weight of a butyl rubber, 60% by weight of a powdered, mineral filler material, each based on the total amount of an anti-corrosion ply. The constituent parts of the anti-corrosion ply have properties as specified in the above description. One of the two anti-corrosion plies also included a flat, circularly perforated metallised rescue foil, which was embedded in one of the two anti-corrosion plies. Alternatively, the metallised rescue foil was introduced separately in a calendering process as described below.

The second three-ply anti-corrosion tape was formed with a three-layer carrier ply, wherein the carrier ply was a carrier layer with an adhesion-promoting layer applied to both surfaces of the latter. The adhesion-promoting layers consisted of 50% by weight of an at least partially pre-cross-linked butyl rubber having the properties specified in the above description. 33.33% by weight of an electron-beam cross-linkable polypropylene, and 16.67% by weight of an ethylene-propylene-diene rubber, with 5-ethylidene-2-norbornene as a diene, wherein the amounts are based on the total amount of the adhesion-promoting layer, and the constituent parts have properties as specified in the above description. The carrier layer consisted of a non-woven material made of polypropylene. The carrier layer had a thickness of 0.4 mm, and the adhesion-promoting plies each had a thickness of 40 μm.

The second three-ply anti-corrosion tape had two anti-corrosion plies, each of which was arranged on a surface of the carrier layer in such a way that the carrier ply was arranged between the two anti-corrosion plies. The two anti-corrosion plies consisted of 30% by weight of a polyisobutylenc. 10% by weight of a butyl rubber, 60% by weight of a powdered, mineral filler material, each based on the total amount of the anti-corrosion ply. The constituent parts of the anti-corrosion layer have properties as specified in the above description. One of the two anti-corrosion plies also included a flat, circularly perforated metallised rescue foil, which was embedded in one of the two anti-corrosion plies.

The first three-ply and the second three-ply tape were pressed in a calendering process with a rubber-coated work roll and a counter roll made of steel. The roll gap was set to 1.0 mm. The two anti-corrosion tapes running into the roll gap were placed on top of each other for pressing in such a way that the anti-corrosion ply of the first three-ply anti-corrosion tape with the perforated metallised rescue foil embedded in it came into contact with one of the two anti-corrosion plies of the second anti-corrosion tape. In the alternative configuration, the metallised perforated rescue foil was introduced separately between the two anti-corrosion plies of the first and second anti-corrosion tapes as they entered the roll gap. The pressed emerging five-layer anti-corrosion tape formed an electrically conductive bonding ply between the carrier ply of the first tape and the carrier ply of the second tape by virtue of the metallised perforated rescue foil, formed from one anti-corrosion ply of each of the first and second anti-corrosion tapes.

1. An anti-corrosion tape comprising at least four plies, wherein at least two plies of the anti-corrosion tape comprise as carrier plies an at least single-layered carrier, wherein at least one layer of the carrier is designed as a carrier layer, wherein at least one further ply of the anti-corrosion tape is designed as a connecting ply and comprises at least one connecting layer, wherein the connecting layer comprises a material selected from a group comprising at least one butyl rubber and/or at least one polyisobutylene, wherein the at least one connecting ply is arranged between the two carrier plies, and wherein at least one further ply of the anti-corrosion tape is configured as an anti-corrosion ply and is arranged on at least one exposed surface of at least one carrier ply.

2. The anti-corrosion tape according to claim 1, wherein the carrier layer of at least one of the carrier plies is formed from at least one carrier material selected from a group comprising polyethylene, polypropylene, polyvinyl chloride, thermoplastic elastomers, and/or metals.

3. The anti-corrosion according to claim 1, wherein the carrier layer of at least one of the carrier plies is formed as a film, non-woven fabric, woven fabric, scrim, knitted fabric, perforated film, or grid.

4. The anti-corrosion tape according to claim 1, wherein an adhesion-promoting layer is arranged on at least one surface of the carrier layer of at least one of the carrier plies.

5. The anti-corrosion tape according to claim 4, wherein the adhesion-promoting ply comprises an adhesion promoting composition comprising
about 20 wt.-% to about 70 wt.-% of at least one polymer selected from a group comprising polyethylenes, polypropylenes, polyvinyl chlorides and/or thermoplastic elastomers; and
about 20 wt.-% to about 65 wt.-% of at least one butyl rubber;
the figures in percent by weight being based in each case on the total amount of the adhesion-promoting layer.

6. The anti-corrosion tape according to claim 4, wherein the carrier layer and the at least one adhesion-promoting layer are coextruded.

7. The anti-corrosion tape according to claim 1, wherein at least one electrically conductive material and at least one core material can be arranged in the at least one connecting ply or in the at least one anti-corrosion ply or in at least one of the at least two carrier plies.

8. A method for applying an anti-corrosion tape according to claim 1 as corrosion protection to pipes, pipelines, tubular objects, pipelines and pipeline components, to tanks and components of tanks and to other installations and fixtures by applying the anti-corrosion tape thereto.

9. The method according to claim 8, wherein the pipes, the pipelines, the tubular objects, the pipelines and the pipeline components as well as the tanks and the components of the tanks are wrapped with the anti-corrosion tape.

10. A method for producing an anti-corrosion tape comprising the steps of:
applying pressure to at least a first, at least two-ply anti-corrosion tape and to at least a second, at least two-ply anti-corrosion tape,
wherein the first and the second anti-corrosion tape comprise at least one carrier ply and at least one anti-corrosion ply, such that the first or the second anti-corrosion tape is brought into contact with the respective other anti-corrosion tape, so that at least one anti-corrosion ply of the first or the second anti-corrosion tape forms a connecting ply, arranged between the carrier plies of the at least one first and second anti-corrosion tape, and the at least one further anti-corrosion ply of the first or second anti-corrosion tape forms an outer ply of the anti-corrosion tape.

11. The method according to claim 10, wherein the at least one first, at least two-ply anti-corrosion tape and the at least one second, at least two-ply anti-corrosion tape are pressed together by a pressing process.

12. The method according to claim 10, wherein a first, two-ply anti-corrosion tape and a second, three-ply anti-corrosion tape, the first anti-corrosion tape comprising a carrier ply and an anti-corrosion ply and the second anti-corrosion tape comprising a carrier ply and two anti-corrosion plies, the carrier ply of the second anti-corrosion tape being arranged between the two anti-corrosion plies thereof, are brought into contact with one another in such a way that the anti-corrosion ply of the first anti-corrosion tape is assigned to one of the two anti-corrosion plies of the second anti-corrosion tape in such a way that these form a connecting ply, arranged between the carrier plies of the first and second anti-corrosion tapes, after pressure has been exerted on the first and second anti-corrosion tapes.

13. The method according to claim 10, wherein the carrier ply of the at least one first or of the at least one second anti-corrosion tape is formed from an at least single-layered carrier, at least one layer of the carrier being formed as a carrier layer, the carrier layer being formed from at least one carrier material selected from a group comprising polyethylene polypropylene, polyvinyl chloride, thermoplastic elastomers and/or metals, and wherein the at least one anti-corrosion ply of the at least one first and/or the at least one second anti-corrosion tape comprises a material selected from a group comprising at least one butyl rubber and/or at least one polyisobutylene.

14. The anti-corrosion tape of claim 7, wherein a use of the anti-corrosion tape is for the protection of pipes, pipelines, tubular objects, pipelines and pipeline components as well as tanks and components of tanks, and other installations and fixtures against corrosion.

15. The anti-corrosion tape of claim 7, wherein a use of the anti-corrosion tape is for localizing at least one defect in a pipe or pipeline in the region of a weld seam, wherein the connecting ply comprises at least one conductive material and/or core material embedded in the at least one connecting ply, which can be arranged at least in the region of a weld seam of a pipe or pipeline.
